(19) United States
(12) Patent Application Publication
(10) Pub. No.: US 2012/0115120 A1
(43) Pub. Date: May 10, 2012

(54) DEVICE FOR TELLING OR LEARNING TO TELL THE TIME

(76) Inventor: Page GOOLRICK, New York, NY (US)

(21) Appl. No.: 12/942,512

(22) Filed: Nov. 9, 2010

(51) Int. Cl. G09B 19/12

(52) U.S. Cl. 434/304

(57) ABSTRACT

A kit that may be assembled to produce a device for telling the time or learning to tell the time, more particularly to a device to assist children to learn how to tell the time by reading conventional analog clock. The kit comprises annular members selected from the group consisting of blank annular members, annular members with markings around the periphery dividing the periphery into a plurality of arcs, and mixtures thereof; and a member having a circular transparent face, a peripheral side wall and an optionally removable central boss on which elongated members extending towards the periphery may be mounted.

### FIELD OF THE INVENTION

The present invention relates to a device for telling the time or learning to tell the time, more particularly to a device to assist children to learn how to tell the time by reading conventional analog clocks having a clock face divided into twelve “hourly” segments.

### BACKGROUND TO THE INVENTION

With the increasing use of digital clocks, young children are becoming less familiar with analog clocks. A variety of tools is available to assist in remedying this. For example the “About.com:mathematics web site describes a method in which children are encouraged to draw hour and minute hands on preprinted clock faces, Grey Oltwitt Educational Software offers an on-line game for assisting children in learning to tell the time.

### SUMMARY OF THE INVENTION

The present invention provides a kit which can be assembled to resemble a clock or be a clock. The kit comprises blank annular members, annular members with markings around the periphery dividing the periphery into a plurality of arcs, and a member having a circular transparent face, a peripheral side wall and an optionally removable central boss on which elongated members extending towards the periphery may be mounted. The side wall may be provided with clips so that the annular members may be held in place within the circular transparent face. The elongated members may be moveable between different positions so as to point towards different points on the periphery of the face. The annular members have a surface that can be marked by markers such as a crayon or ink-based marker. If desired, the central boss may contain a clock mechanism to cause the elongated members to rotate around the the face so that the assembled kit functions as a clock.

### BRIEF DESCRIPTION OF THE DRAWINGS

FIG. 1 shows a blank annular member that may be used in a kit of the present invention that has ben marked with numerals to resemble a clock face.

FIG. 2 shows front view of a member with a circular transparent face of use in the kit of the present invention.

FIG. 3 shows a rear view of a member with a circular transparent face of use in the kit of the present invention.

FIG. 4 shows the assembly of a blank annular member with a member having a circular transparent face as shown in FIG. 2.

FIG. 5 shows the assembly of an annular member as shown in FIG. 1 with a a member having a circular transparent face as shown in FIG. 2.

FIG. 6 shows a plurality of blank annular members.

FIG. 7 shows a plurality of annular members marked around their periphery.

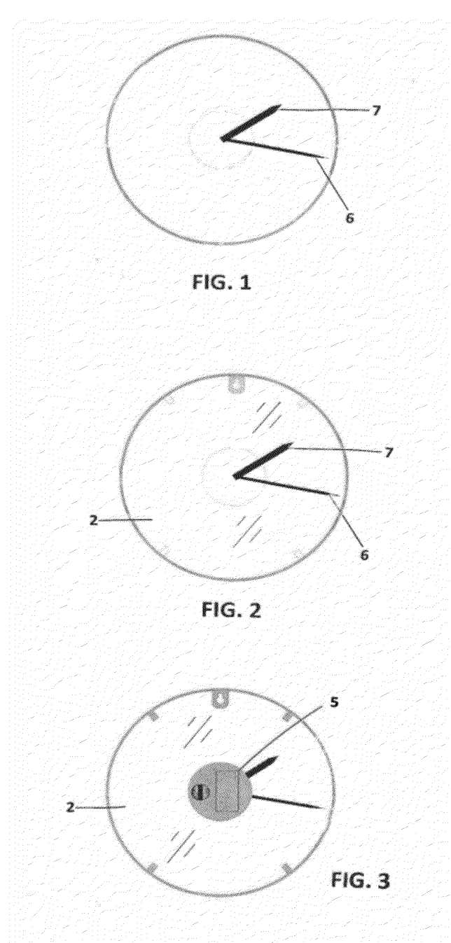

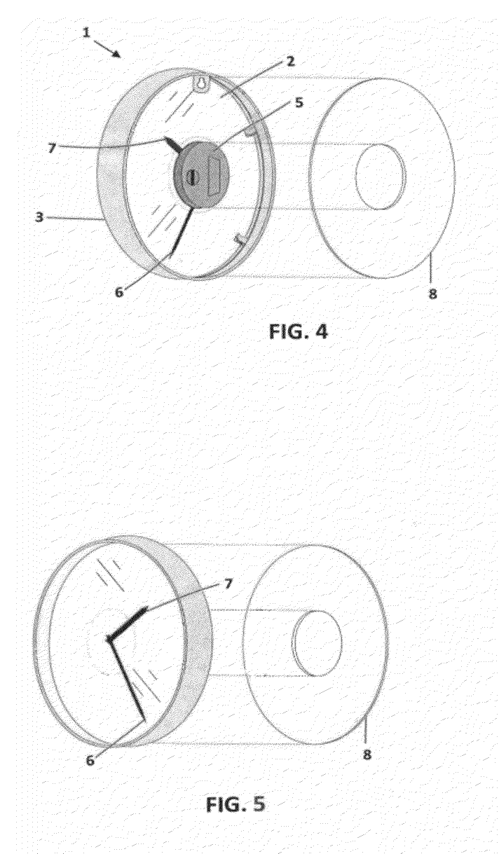

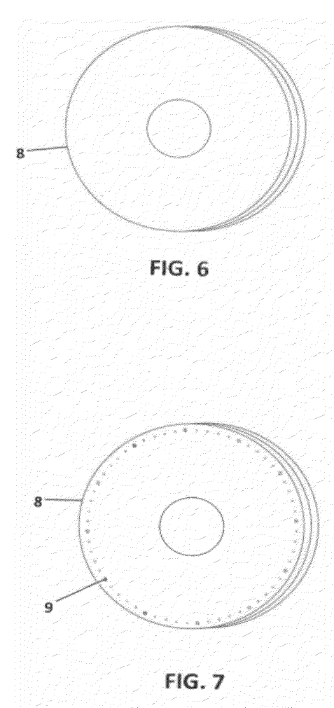

### DETAILED DESCRIPTION OF THE INVENTION

The kit of the present invention enables one to assemble a clock face with hands showing the time while permitting a user to design his or her own clock face by making appropriate markings and drawings on the annular members that will be placed in the main “clock member”, the member with a transparent face.

The member with a transparent face 1 comprises a transparent face 2 surrounded by a peripheral side wall 3. Clips or other mounting devices 4 may be mounted on the peripheral side wall to hold annular members within the structure. The transparent-faced member 1 has a central boss 5 on which elongated members 6, 7 resembling the hands of a clock are mounted. The boss 5 may be permanently affixed to the transparent face 2 or may be detachable, for example by fitting into a circular central aperture in the transparent face. Annular members 8 may be mounted on the boss, the dimensions of the inner circumference of the annulus being compatible with those of the circumference of the boss so as to permit mounting of an annular member 8 on the boss 5.

The annular members have a surface on which markings can be made in using any convenient marking instrument. A kit according to the present invention will typically include some annular members that are blank and some that have markings 9 around the periphery to give guidance as to where the “hour” numbers of a clock face should be located. If desired, however annular members of only one type may be present.

As noted above, the kit contains a central boss on which the elongated members forming the “hands” of the clock. This boss may contain a clock mechanism of any convenient type, such as a clockwork or quartz mechanism. If this is the case, the mechanism will be operably linked to the elongated members and when assembled, the kit can function as a conventional analog clock. Alternatively, the boss may simply have the elongated members mounted on it in such a way that they may be moved to different positions on the clock face and the assembled device used as an educational aid to assist in teaching children to tell time. If desired, the kit can contain bosses of both types so that a child can graduate from playing with the location of the hands to actually telling time in a real life situation. In an alternative construction, a single boss containing a clock mechanism is provided but this also contains a mechanism whereby the hands may be positioned manually, as in an old fashioned long case clock but once positioned, will be caused by the clock mechanism to move around the clock face.

Irrespective of whether the kit is to be assembled as a working clock or an educational device, the user may decorate the annular members in whatever way he or she desires. Such decoration may be effected by any convenient means, including manual application of a design or simply printing an appropriate design on to the annular members by printer linked to a computer or other image processing device. When being used as an educational device, it will be normal to include markings around the periphery to indicate hours, and if desired minutes. Foe other uses, such markings may be dispensed with and the annular members may be marked in a purely decorative manner. I this way one could, for example choose to have a different clock face on the same clock for different days of the week or different times of the day.

In use, when the kit is being used as an educational device, an annular member will be marked by someone learning to tell the time or by an instructor. In the early stages of learning, such markings will typically involve placing the numbers one to twelve around the periphery of the member as conventionally shown on a clock face. The annular member and the “clock member will then be assembled and a particular “time” depicted. The annular member may then be replaced with a different annular member marked differently. After a number of such members have been used, non-numerical markings may be used so as to establish the idea that it is the location of the elongated members (clock “hands”) that indicate the time rather than the hands having to point to any particular numbers to provide this information.

1. A kit comprising; annular members selected from the group consisting of blank annular members, annular members with markings around the periphery dividing the periphery into a plurality of arcs, and mixtures thereof; and
a member having a circular transparent face, a peripheral side wall and an optionally removable central boss on which elongated members extending towards the periphery may be mounted.

2. A kit as claimed in claim 1, wherein the side wall is provided with clips so that the annular members may be held in place within the circular transparent face.

3. A kit as claimed in claim 1, wherein said boss comprises a clock mechanism so that when assembled the kit may function as a clock.

4. A kit as claimed in claim 1, wherein the elongated members may be moveable between different positions so as to point towards different points on the periphery of the face.

5. A kit as claimed in claim 1, which further comprises a marker.
